(19) United States
(12) Patent Application Publication
(10) Pub. No.: US 2023/0291971 A1
(43) Pub. Date: Sep. 14, 2023

(54) VIDEO MIRRORING METHOD AND APPARATUS, AND ELECTRONIC DEVICE AND STORAGE MEDIUM

(71) Applicant: Beijing Bytedance Network Technology Co., Ltd., Beijing (CN)

(72) Inventors: Yangruoying KAN, Beijing (CN); Zhanzhan LI, Beijing (CN); Jie DANG, Beijing (CN); Yan ZHAO, Beijing (CN); Yuhang GUO, Beijing (CN); Yingjie SUN, Beijing (CN)

(21) Appl. No.: 18/019,425

(22) PCT Filed: Aug. 6, 2021
(86) PCT No.: PCT/CN2021/111098

§ 371 Date: Feb. 2, 2023

(30) Foreign Application Priority Data
Aug. 6, 2020 (CN) 202010784295.1

(51) Int. Cl. H04N 21/472; H04N 21/41; G06F 3/04817

(52) U.S. Cl. CPC H04N 21/47217; H04N 21/4122; G06F 3/04817

(57) ABSTRACT

Disclosed in embodiments of the present disclosure are a video mirroring method and apparatus, and an electronic device and a storage medium. A currently played first video is mirrored to a second device according to a mirroring enable instruction of a user, and after the first video is mirrored to the second device, the playback progress of the first video is monitored; when it is determined according to the playback progress of the first video that the mirroring of the first video is completed, a mirroring device can automatically mirror a second video to the second device, such that after the mirroring of the previous video is finished, a next video can be continuously mirrored, and the user does not need to perform a mirroring operation after the mirroring of the previous video is finished. That is, a plurality of videos can be continuously played on the second device, the user does not need to frequently perform the mirroring operation in the process, and the next video is automatically mirrored when the mirroring of the previous video is completed, such that the second device can automatically and continuously perform mirroring, the mirroring efficiency is improved, and the user experience is improved.

This application claims priority to Chinese Patent Application No. 202010784295.1, titled “VIDEO MIRRORING METHOD AND APPARATUS, AND ELECTRONIC DEVICE AND STORAGE MEDIUM”, filed on Aug. 6, 2020 with the China National Intellectual Property Administration (CNIPA), which is incorporated herein by reference in its entirety.

### FIELD

The present disclosure relates to the technical field of video processing, and in particular, to a video projection method and apparatus, electronic device and storage medium.

### BACKGROUND

With the continuous development of video processing technology, users can watch videos on terminal devices. In addition, in order to increase the flexibility of a user to watch a video, the terminal device may project the played video to another device for playback. For example, a terminal device projects a video to a TV for playback.

However, each time a video projection is completed, the user needs to perform a projection operation again, so that the terminal device can project the next video to another device for playback. In the case of many videos, the user needs to perform projection operations frequently, resulting in low projection efficiency and thereby reducing user experience.

### SUMMARY

In order to solve or at least partially solve the above technical problems, a video projection method and apparatus, an electronic device and a storage medium are provided according to embodiments of the present disclosure, which improve the projection efficiency and thus improve the user experience.

A video projection method is provided in an embodiment of the present disclosure, which is applied to a first device. The method includes:
receiving, by the first device, a start projection command;
projecting, by the first device, a first video to a second device in response to the start projection command;
acquiring, by the first device, a playback progress of the first video on the second device; and
determining, by the first device, that a projection of the first video is completed according to the playback progress of the first video on the second device; and projecting a second video to the second device, in response to a determination of the projection of the first video being completed.

A video projection apparatus is provided in an embodiment of the present disclosure. The apparatus includes: a receiving module, a response module, an acquisition module and a project module.

The receiving module is configured to receive a start projection command.

The response module is configured to project a first video to a second device in response to the start projection command.

The acquisition module is configured to acquire a playback progress of the first video on the second device.

The projection module is configured to determine that a projection of the first video is completed according to the playback progress of the first video on the second device; and project a second video to the second device, in response to a determination of the projection of the first video being completed.

An electronic device is further provided according to an embodiment of the present disclosure. The electronic device includes:
one or more processors; and
a storage device configured to store one or more programs,
where the one or more programs, when executed by the one or more processors, cause the one or more processors to implement the above video projection method.

A computer-readable storage medium is also provided according to an embodiment of the present disclosure. A computer program is stored on the computer-readable storage medium. The program, when executed by a processor, implements the above video projection method.

Compared with the conventional technology, the technical solutions provided by the embodiments of the present disclosure have the following advantages. In the video projection method according to the embodiments of the present disclosure, the first device projects a currently played first video to a second device according to a start projection command of a user. After the first video is projected to the second device, a second video is automatically projected by the first device to the second device in response to determining that the projection of the first video is completed according to the playback progress of the first video on the second device. In this way, the next video is automatically projected when the projection of the previous video is completed, and the user does not need to perform a projection operation when the projection of the previous video is completed. That is to say, the first device can continuously project multiple videos to the second device, without frequent projection operations of the user. By automatically projecting the next video when the projection of the previous video is completed, the projection efficiency is improved, thereby improving user experience.

### BRIEF DESCRIPTION OF THE DRAWINGS

The above and other features, advantages and aspects of various embodiments of the present disclosure will become more apparent when taken in conjunction with the accompanying drawings and with reference to the following detailed description. Throughout the drawings, the same or similar reference numbers refer to the same or similar elements. It should be understood that the drawings are schematic and that components and elements are not necessarily drawn to scale.

FIG. 1 is a flowchart of a video projection method according to an embodiment of the disclosure;

FIG. 2 is a schematic diagram of an application scenario according to an embodiment of the present disclosure;

FIG. 3 is a schematic diagram of a user interface according to an embodiment of the present disclosure;

FIG. 4 is a schematic diagram of another application scenario according to an embodiment of the present disclosure;

FIG. 5 is a flowchart of a video projection method according to an embodiment of the present disclosure;

FIG. 6 is a flowchart of another video projection method according to an embodiment of the present disclosure;

FIG. 7 is a schematic diagram of another user interface according to an embodiment of the disclosure;

FIG. 8 is a flowchart of another video projection method according to an embodiment of the present disclosure;

FIG. 9 is a schematic diagram of another user interface according to an embodiment of the disclosure;

FIG. 10 is a flowchart of another video projection method according to an embodiment of the disclosure;

FIG. 11 is a flowchart of another video projection method according to an embodiment of the disclosure;

FIG. 12 is a schematic structural diagram of a video projection apparatus according to an embodiment of the disclosure; and

FIG. 13 is a schematic structural diagram of an electronic device according to an embodiment of the disclosure.

### DETAILED DESCRIPTION OF EMBODIMENTS

Embodiments of the present disclosure will be described in more detail below with reference to the accompanying drawings. While certain embodiments of the present disclosure are shown in the drawings, it should be understood that the present disclosure may be embodied in various forms and should not be construed as limited to the embodiments set forth herein, but rather the embodiments are provided for the purpose of more thorough and complete understanding of the present disclosure. It should be understood that the drawings and embodiments of the present disclosure are only for exemplary purposes, and are not intended to limit the protection scope of the present disclosure.

It should be understood that the various steps described in the method embodiments of the present disclosure may be performed in different orders and/or in parallel. Furthermore, method embodiments may include additional steps and/or omit performing the illustrated steps. The scope of the present disclosure is not limited in this regard.

As used herein, the term “including” and variations thereof are open-ended inclusions, i.e., “including but not limited to”. The term “based on” is “based at least in part on.” The term “an embodiment” means “at least one embodiment”. The term “another embodiment” means “at least one additional embodiment”. The term “some embodiments” means “at least some embodiments”. Relevant definitions of other terms will be given in the description below.

It should be noted that concepts such as “first” and “second” mentioned in the present disclosure are only used to distinguish different devices, modules or units, and are not used to limit the order of functions performed by these devices, modules or units or the interdependence thereof.

It should be noted that the modifications of “a” and “a plurality of” mentioned in the present disclosure are illustrative rather than restrictive, and those skilled in the art should understand that unless it is clearly stated in the context, they should be understood as “one or more”.

The names of messages or information exchanged between multiple apparatuses in the embodiments of the present disclosure are only for illustrative purposes, and are not intended to limit the scope of these messages or information.

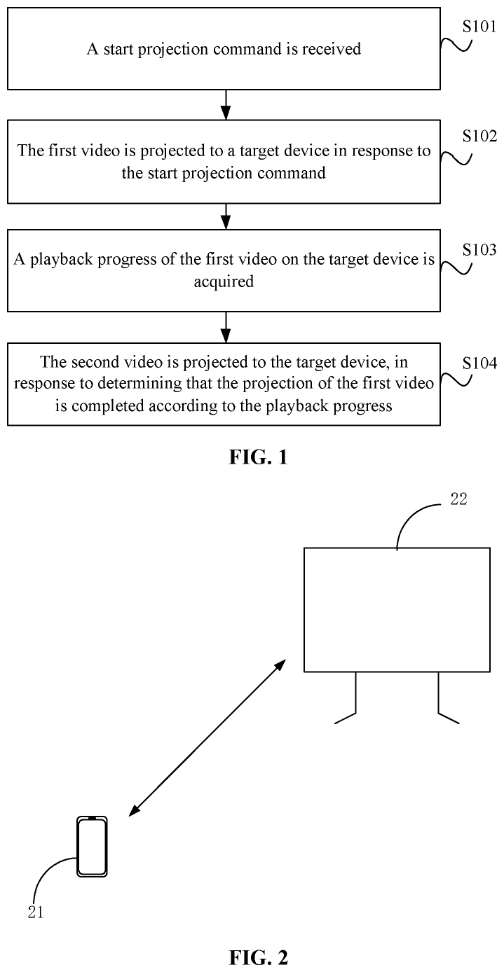

FIG. 1 is a flowchart of a video projection method according to an embodiment of the present disclosure. This embodiment may be applied to the case of video projection in a client. The method may be executed by a video projection apparatus, and the apparatus may be implemented by software and/or hardware. When the apparatus is implemented by software, the apparatus may be configured in an electronic device, such as a mobile terminal, specifically including a mobile phone, computer or tablet computer. When the apparatus is implemented by hardware, the apparatus may be the above electronic device. For ease of understanding, the following description is made by taking the apparatus as a first device as an example.

As shown in FIG. 1, the method may be applied to the first device, and the method includes the following steps S101 to S104.

In S101, a start projection command is received.

As shown in FIG. 2, the first device 21 may be configured with a video projection apparatus. Specifically, the first device 21 may project, through the video projection apparatus, a video played on the first device 21 to a second device 22 for playback. The first device 21 may specifically be a mobile phone, and the second device 22 may specifically be a TV. In other embodiments, the first device 21 is not limited to being a mobile phone. For example, the first device may be a terminal device other than a mobile phone. Similarly, the second device 22 is not limited to being a TV. For example, the second device may be other device with video playback function. In some embodiments, the first device 21 may be referred to as a projecting device. The second device 22 may be referred to as a projected device. For example, a mobile phone may be referred to as a projecting device, and a TV may be referred to as a projected device.

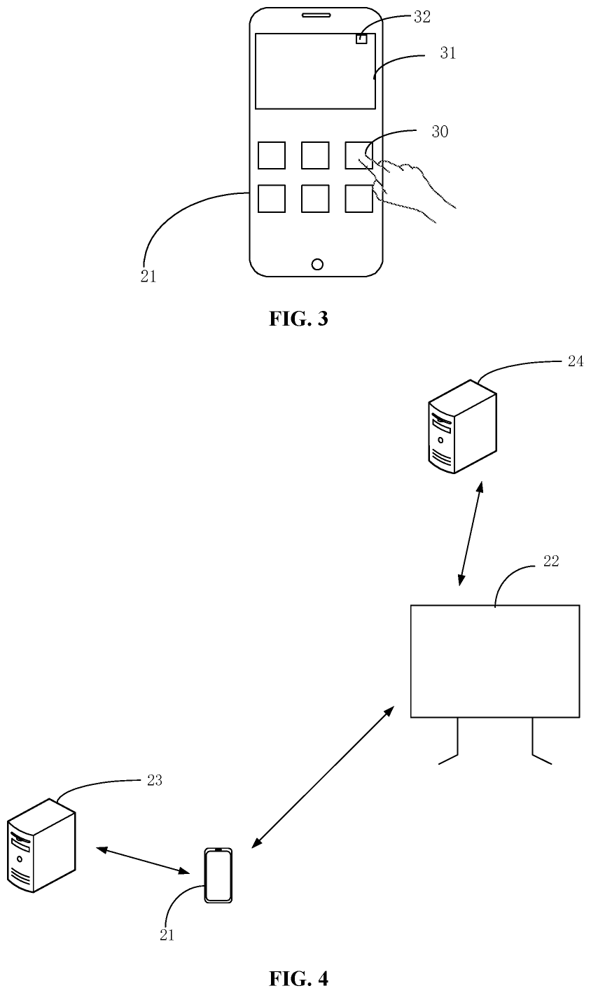

FIG. 3 shows a user interface of the first device 21. The user interface may be provided by a video application program installed in the first device 21. Specifically, the video application program may be an application program for playing videos. It can be understood that the above user interface is only a schematic illustration, and does not limit the content displayed on the user interface or the layout of the displayed content on the user interface. As shown in FIG. 3, thumbnails of multiple videos may be displayed on the user interface. For example, 30 represents any one of the multiple thumbnails. The player in the video application program of the first device 21 may be recorded as a first player. After the user operates the thumbnail 30 on the user interface of the first device 21, the first device 21 may play the video corresponding to the thumbnail 30 in the first player 31 in the user interface. Specifically, the first player 31 may be a video player. Here, the video currently played by the first player 31 may be recorded as a first video. Specifically, the user's operations on the projection button 32 are not limited to operations such as clicking, long pressing, and double-clicking, which may also be other operations.

In addition, the user's operation on the user interface may also trigger a start projection command, so that the first device 21 can receive the start projection command triggered by the user. For example, a projection button 32 is displayed in the user interface of the first device 21. For example, while the first player 31 is playing the first video, a prompt “Try to project to the TV to watch it” may be displayed around the projection button 32. If the user wishes to project the first video to the TV, the user may operate the projection button 32 to trigger the start projection command. The position of the projection button 32 in the user interface is not limited here. For example, the projection button 32 may be displayed in the upper right corner of the first player 31. Alternatively, the projection button 32 may be displayed in other position of the user interface. In addition, the position of the projection button 32 in the user interface may be fixed or non-fixed. When the position of the projection button 32 in the user interface is not fixed, the projection button 32 may be dragged by the user to a certain position on the user interface.

In an embodiment, the user may activate the projection function of the first device 21 or the video application program by an operation on the projection button 32. For the convenience of description, the following description will be given by taking the activation of the projection function of the first device 21 as an example. For example, when the user operates the projection button 32, the user may trigger a start projection command. When receiving the start projection command, the first device 21 may activate the projection function of the first device 21 according to the start projection command. Specifically, the user's operations on the projection button 32 are not limited to operations such as clicking, long pressing, and double-clicking, which may also be other operations.

In S102, the first video is projected to a target device in response to the start projection command.

The target device may be the second device. Unless otherwise specified, the target device and the second device both refer to the projected device. In some possible embodiments, when the first device 21 receives the start projection command of the user, the first device 21 may display a projection guide page. Since a certain amount of traffic needs to be consumed in a process of the first device projecting the video, the projection guide page may prompt the user to connect the first device 21 to a surrounding wireless fidelity (Wireless-Fidelity, Wi-Fi) hotspot. Specifically, the projection guide page may display names of Wi-Fi hotspots around the first device 21, and the first device 21 may connect to the Wi-Fi hotspot according to the user's click operation on the name of a Wi-Fi hotspot. Further, the first device 21 may search for projectable devices around, such as a projectable TV. In the process of the first device 21 searching for a projectable device, the projection guide page may prompt “Searching for a projectable device”. When the network connection signal between the first device 21 and the projectable device is weak, the projection guide page may prompt “Please check the network connection”. When the projectable devices around the first device 21 are not connected to the Wi-Fi hotspot, the projection guide page may prompt “Please keep the mobile phone and the TV under the coverage of the same Wi-Fi hotspot”.

It should be noted that the connection between the first device 21 and the projectable device is not limited to Wi-Fi, which may be other wireless connection, such as Bluetooth. In other embodiments, the connection may also be a wired connection. After the first device 21 establishes a connection with the projectable device, the projectable device may be called a projected device, that is, the second device 22 described above.

In an embodiment, when the first device 21 detects a surrounding projectable device, the projection guide page may display an identification of the projectable device. When there are multiple projectable devices, the arrangement order of the identifications of the multiple projectable devices in the projection guide page is not limited in the present embodiment. For example, the identification of the projectable device arranged in the first place may be the identification of the projectable device connected to the first device 21 last time.

Further, the first device 21 may automatically reconnect with the projectable device that was connected last time. In other embodiments, the first device 21 may establish a connection with a projectable device selected by the user, according to a selection operation of the user on an identification of one projectable device among the identifications of multiple projectable devices.

In an embodiment, the first device 21 may send a first projection command to the second device. The first projection command includes video information of the first video, and the first projection command is used to control the second device 22 to play the first video according to the video information of the first video.

After the first device 21 establishes a connection with the second device 22, the first device 21 may send the first projection command to the second device 22. The first projection command includes video information of the first video. In an embodiment, the video information of the first video includes at least one of: video data of the first video and a video address of the first video.

In a possible embodiment, after receiving the first projection command, the second device 22 may directly play the first video according to the video information of the first video. For example, the second device 22 may project and display the first video.

In another possible embodiment, the first projection command is used to control the second device 22 to activate the second player. For example, after the second device 22 receives the first projection command, the second device 22 may activate the player in the second device 22 according to the first projection command. The player in the second device 22 may be recorded as the second player. The second device 22 may control the second player in the second device 22 to play the first video according to the video information of the first video. The second player may record or cache video information of the video played by the second device 22, such as video data of the first video or the video address of the first video. When the user needs to watch the first video on the second device 22, the user may search for the video information of the first video in the second player to make the second player directly play the first video. In this way, the user does not need to use the first device 21 to perform a projection operation on the video played by the second device 22 again, which further improves the projection efficiency.

In some embodiments, after the first device 21 sends the first projection command to the second device 22, the first device 21 may further send a projection command to the second device 22 at least once. For example, after the first device 21 sends the first projection command to the second device 22, the first device 21 may send to the second device 22 a second projection command, a third projection command, and the like. The second projection command is used to control the second player in the second device to start. The third projection command may also be used to control the second device 22 to activate the second player. Taking the second projection command as an example, the second projection command may not only be used to control the second device 22 to project and play other videos different from the first video, but also control the second device 22 to activate the second player. Thus, the second device 22 can control the second player to play the second video.

A process of the first device 21 projecting the first video currently played in the first player 31 to the second device 22 for playback may be implemented by several implementations as follows.

In a first implementation, the first device 21 sends video data of the first video currently being played in the first player 31 to the second device 22, through a wireless transmission channel between the first device 21 and the second device 22. The video data may be each frame of image data and each frame of audio data in the video. The second device 22 plays the first video after receiving the video data of the first video. In the first implementation, the first device 21 and the second device 22 may play the first video synchronously, that is, the playback progress of the first video on the first device 21 is synchronized with the playback progress of the first video on the second device 22.

In a second implementation, as shown in FIG. 4, the first device 21 may obtain the video address of the first video currently played in the first player 31 from a server 23 corresponding to the video application program. The video address may be a uniform resource locator (Uniform Resource Locator, URL). The first device 21 sends the video address of the first video to the second device 22. The second device 22 plays the first video after acquiring the video data of the first video according to the video address of the first video. In some examples, the first video is stored in the server 24, and the second device 22 may acquire the video data of the first video from the server 24 according to the video address of the first video.

It should be noted that the server 23 and the server 24 may be the same server or different servers. In the second implementation, after the first device 21 sends the video address of the first video to the second device 22, the first device 21 may pause playing the first video, thereby reducing the power consumption of the first video. In the second case, the first device 21 may not pause playing the first video.

In an embodiment, the video information of the first video may further include a projection parameter of the first video. The projection parameter includes at least one of: playback progress, resolution, and playback volume.

In some embodiments, the video information of the first video sent by the first device 21 to the second device 22 includes the playback progress of the first video in the first device 21. When the first video is played to 30% on the first device 21, the user activates the projection function, and the first device 21 may send the playback progress 30% of the first video to the second device 22, so that the second device 22 may continue to play the first video from the play progress 30%. In addition, the second device 22 may play the first video according to projection parameter such as the resolution and playback volume of the first video.

In S103, a playback progress of the first video on the target device is acquired.

The playback progress of the first video on the target device may be the playback progress of the first video on the second device. In some embodiments, after projecting the first video currently played in the first player 31 to the second device 22 for playback, the first device 21 may monitor the playback progress of the first video in real time. Alternatively, the first video 21 may monitor the playback progress of the first video in non-real time.

In some examples, in the case that the first device 21 sends the video data of the first video to the second device 22, the first device 21 and the second device 22 play the first video synchronously, and the playback progress of the first video on the first device is synchronized with the playback progress of the first video on the second device. The first device 21 may monitor the playback progress of the first video on the first device 21 in real time.

In other examples, the first device 21 sends the video address of the first video to the second device 22. The second device 22 may obtain, according to the video address of the first video, video data corresponding to the video address of the first video from the server 24 and play. Since the first device 21 and the second device 22 may obtain different information such as source of the video data of the first video, the playback progress of the first video on the first device 21 does not affect the playback progress of the first video on the second device 22. Therefore, when the second device 22 plays the first video, the first device 21 may pause playing the first video. At this time, the first device 21 may monitor the playback progress of the first video on the second device 22 in real time. For example, the second device 22 may send the playback progress of the first video on the second device 22 to the first device 21 in real time. Alternatively, the second device 22 may send the playback progress of the first video on the second device 22 to the first device 21 when the second device 22 is about to finish playing the first video, such that the first device 21 sends the second projection command to the second device 22 to project the second video to the second device 22.

In S104, the second video is projected to the target device, in response to determining that the projection of the first video is completed according to the playback progress.

In some embodiments, when the first device 21 determines that the projection of the first video on the second device 22 is completed according to the playback progress of the first video on the second device, the first device 21 may automatically project the second video to the second device 22, such that the projected video played on the second device 22 can be continuous without further manual projection operation by the user.

In an embodiment, when the first device 21 determines that the projection of the first video is completed according to the playback progress of the first video on the second device, the first device 21 sends a second projection command to the second device 22. The second projection command includes video information of the second video, and the second projection command is used to control the second device 22 to play the second video according to the video information of the second video.

In some examples, when the first device 21 determines that the projection of the first video on the second device 22 is completed, the first device 21 sends the second projection command to the second device 22. The second projection command includes the video information of the second video. The video information of the second video includes video data or video address of the second video. Similarly, the second device 22 may play the second video synchronously with the first device 21 according to the video data of the second video. Alternatively, the second device 22 may obtain the video data of the second video from the server 24 according to the video address of the second video, and play the second video.

In a possible implementation, after receiving the second projection command, the second device 22 may directly play the second video according to the video information of the second video. For example, the second device 22 may project and display the second video.

In another possible implementation, the second projection command is used to control the second device to activate the second player. For example, after the second device 22 receives the second projection command, the second device 22 may activate the player in the second device 22 according to the second projection command, and the player in the second device 22 may be recorded as the second player. The second device 22 may control the second player in the second device 22 to play the second video according to the video information of the second video. Similarly, the second player may record or cache video information of the video played by the second device 22, such as video data of the second video or video address of the second video. When the user needs to watch the second video on the second device 22, the user may search for the video information of the second video in the second player to make the second player directly play the second video. In this way, the user does not need to use the first device 21 to perform a projection operation on the video played by the second device 22 again, which further improves the projection efficiency.

In an embodiment, the first device 21 may obtain video information of the second video; determine that the projection of the first video is completed, according to the playback progress of the first video on the second device; and send the second projection command to the second device 22 according to the video information of the second video in response to completing the projection of the first video.

In some embodiments, the first device 21 may pre-acquire video information of the second video. In response to determining that the projection of the first video on the second device 22 is completed, the first device 21 sends the second projection command to the second device 22 according to the pre-acquired video information of the second video.

The first device 21 may acquire the video information of the second video through the following implementations.

In a first implementation, the first device 21 obtains the video information of the second video from a video information list. The video information list includes video information of one or more videos. In some examples, the video in the video information list may be a video to be played after the first video, such as the second video.

The video information list may be pre-stored in the first device 21 or in the video application program. The video information of the second video may be video information of any video in the video information list. For example, the video information of the second video is video information of the first video in the video information list. The video information of the video in the video information list may be stored in the first device 21 or in the video application program of the first device 21 before the first device 21 plays the first video. The video information of the video in the video information list may also be stored when or after the first device 21 plays the first video. In addition, the first video may also be a video in the video information list.

In a second implementation, the first device 21 obtains video information of the second video from the server. In some examples, when the video information list is empty, the first device 21 may send an acquisition request to the server 23 to acquire video information of one or more videos. The video information of the second video may be any one of the video information of the one or more videos, or may be video information of a video at a preset position in the playlist. For example, the preset position may be ranked after the first video in the playlist.

In some embodiments, the first device 21 may acquire video information of the second video when the playback progress of the first video is greater than or equal to a preset progress. The first device 21 may acquire video information of the second video before the first video is fully played. For example, the first device 21 may acquire the video information of the second video when the playback progress of the first video reaches 70%-90%. The first device 21 may also acquire video information of the second video when the first video is fully played. For example, the first device 21 may acquire video information of the second video when the playback progress of the first video reaches 100%.

In this embodiment, the first device 21 may determine that the projection of the first video on the second device 22 is completed, according to the playback progress of the first video on the second device 22 in the following implementations.

In the first possible case, the completion of the projection of the first video may specifically be that the playback of the first video on the second device 22 is completed. For example, the playback progress of the first video on the second device 22 reaches 100%. When the playback progress of the first video on the first device 21 is synchronized with the playback progress of the first video on the second device 22, the completion of the projection of the first video may also mean that the playback of the first video on the first device 21 is completed.

In the second possible case, the projected video (e.g., the first video) played on the second device 22 includes a head part, a plot part and an end part, which are played in sequence. The preset progress may be a playback progress when the playback of the plot part of the projected video is completed, or a playback progress when the playback of the end part of the projected video is completed.

In some examples, the playback progress of the first video on the second device reaching a preset progress indicates a progress that the playback of the plot part (main content) of the first video on the second device 22 is completed. For example, the first video is an episode of TV drama that includes a head part, a plot part and an end part. Ratio information of each part of the head part, the plot part and the end part in the episode may specifically be a ratio of the duration of each part in the episode to the total duration of the episode. The total duration of the episode is, for example, 40 minutes, with the head part accounting for 2 minutes, the plot part accounting for 36 minutes, and the end part accounting for 2 minutes. The completion of the projection of this episode may specifically be that the playback of the plot part of this episode on the second device 22 is completed. That is, if 40 minutes are taken as 100% progress, the playback progress of this episode reaches 5% when the playback of the head part is completed; the playback progress of this episode reaches 95% when the playback of the plot part is completed; and the playback progress of this episode reaches 100% when the playback of the end part is completed. In this way, the preset progress may be 95% or 100%.

The episode corresponding to the first video may be sourced from the server 23. The server 23 may count a ratio of each part of the head part, plot part and end part of each episode of the TV drama to the episode. The server 23 may send to the first device 21 time stamp information or the ratio information of each part of the head part, plot part and end part of each episode of the TV drama to the episode. In the process of playing the first video by the second device 22, the first device 21 determines that the playback progress of the first video reaches the preset progress, i.e., 95%, When the first device 21 determines that a ratio of the head part and the plot part of the first video to the first video is 95%, the first device 21 may determine that the main content of the first video, that is, the plot part, has been fully played on the second device 22. At this time, it may be determined that the projection of the first video is completed. Then, the first device 21 may project the second video to the second device 22 for playback according to the video information of the second video. In this way, the end part may be automatically skipped when the video is projected.

In the video projection method according to the embodiments of the present disclosure, the first device projects a currently played first video to a second device in response to a start projection command of a user. After the first video is projected to the second device, the first device monitors the playback progress of the first video. When the projection of the first video is determined to be completed according to the playback progress of the first video, the first device automatically projects a second video to the second device. In this way, the next video is automatically continued to be projected when the projection of the previous video is completed, and the user does not need to perform a projection operation when the projection of the previous video is completed. That is, multiple videos may be continuously projected to the second device, without frequent projection operations of the user during this process. By automatically projecting the next video in response to the completion of the projection of the previous video, automatically continuous projection can be performed on the second device, thereby improving the projection efficiency and user experience.

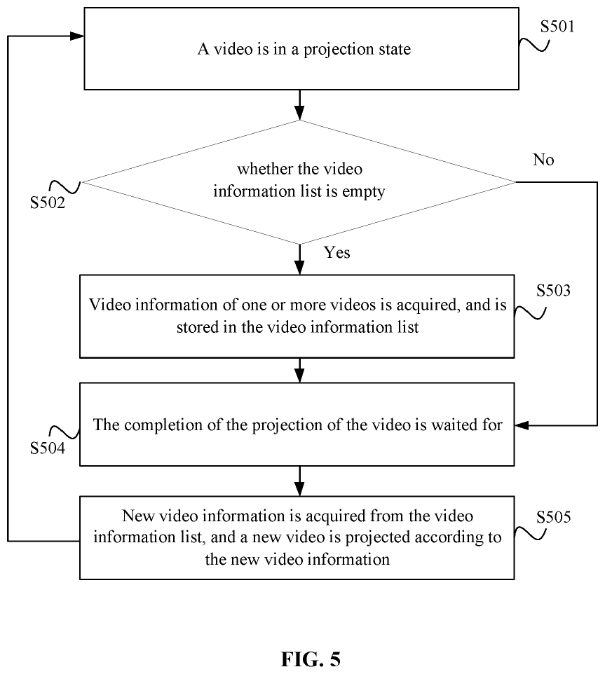

FIG. 5 is a schematic diagram of a video projection method according to an embodiment. The method includes the following steps S501 to S505.

In S501, a video is in a projection state.

The projection function is activated in response to the user clicking the projection button 32. The first device 21 or the video application program installed on the first device 21 enters the projection state. Taking the first device 21 as an example, when the video of the first device 21 is projected to the second device 22 for playback, the first device 21 enters the projection state. The projection state may be stored in the first device 21.

When the first device 21 is turned on or the video application program is in the life cycle, the first device 21 or the video application program may memorize the projection state. The projection state may indicate that the first device 21 or the video application program is currently performing a projection operation. The life cycle of the video application program may specifically be the running period of the video application program, and the running period may include a running period at the front end or may also include a running period at the background.

In S502, it is determined whether the video information list is empty. S503 is performed if the video information list is empty; or S504 is performed if the video information list is not empty.

The video information list may be pre-stored in the first device 21 or in the video application program. The video information list may include video information of one or more videos. When the first device 21 or the video application program enters the projection state, the first device 21 may detect whether the video information list is empty.

In S503, video information of one or more videos is acquired, and is stored in the video information list.

In some examples, when the first device 21 detects that the video information list is empty, the first device 21 may acquire the video information of one or more videos from the server 23, and store the video information of the one or more videos in the video information list.

In other examples, when the first device 21 detects that the video information list is empty, the first device 21 may send an acquisition request to the server 23 according to the video information of the first video, so as to acquire video information of the second video related to the first video. The first device 21 may store the video information of the second video in the video information list. Similarly, the first device 21 may further acquire video information of more videos from the server 23 and store them in the video information list.

In S504, the completion of the projection of the video is waited for.

When the first device 21 detects that the video information list is not empty, the first device 21 waits for the completion of the projection of the first video.

In S505, new video information is acquired from the video information list, and a new video is projected according to the new video information.

The new video may be the second video, and the new video information may be video information of the second video. When the first device 21 determines that the projection of the first video is completed, the first device 21 acquires new video information from the video information list. After the first device projects the second video to the second device, the process may return to S501. S501 to S505 are repeatedly performed, so as to realize uninterrupted video projection.

In the video projection method according to the embodiment of the present disclosure, the first device 21 determines whether the video information list is empty. If the video information list is empty, the first device 21 acquires the video information of one or more videos, and stores the video information of the one or more videos in the video information list, so that the video information of available videos is always in the video information list. Thus, the first device can continuously project the videos in the video information list to the second device. When the playback progress of the first video is greater than or equal to the preset progress, the first device 21 acquires video information of the second video from the video information list. When the projection of the first video has not been completed, the first device 21 acquires the video information of the second video in advance from the video information list. Thus, it is ensured that the second video is immediately projected to the second device 22 when the projection of the first video is completed, so that the second device plays the second video in time.

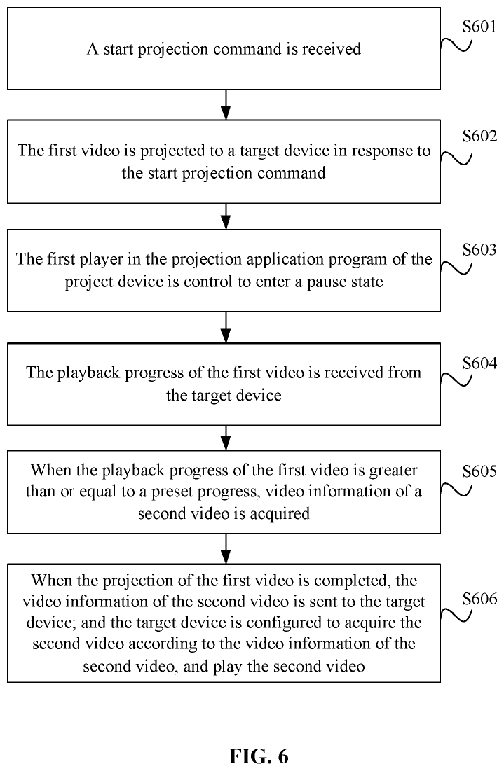

FIG. 6 is a flowchart of another video projection method according to an embodiment of the present disclosure. This embodiment further specifically describes the video projection method on the basis of the above embodiment. Correspondingly, as shown in FIG. 6, the method of this embodiment is applied to the above first device 21, and specifically includes the following S601 to S606.

In S601, a start projection command is received.

The implementation processes and specific principles of S601 are similar to that of S101, which will not be repeated here.

In S602, the first video is projected to the target device in response to the start projection command.

The implementation processes and specific principles of S602 are similar to that of S102, which will not be repeated here.

In S603, the first player in the projection application program of the project device is control to enter a pause state.

The projection device may be the first device 21. If the video application program in the first device 21 has a projection function, the video application program may also be referred to as a projection application program. In some embodiments, the first device 21 sends the video address of the first video currently played in the first player 31 to the second device 22. The second device 22 may acquire video data of the first video from the server 24 according to the video address of the first video, and play the first video. In some possible embodiment, the playback progress of the first video played in the first player 31 of the first device 21 does not affect the playback progress in the second player of the second device 22, that is, the playing of the first video by the second device 22 is not subject to the playing of the first video in the first device 21. Therefore, after the first device 21 projects the first video to the second device 22, the first device 21 may control the first player 31 to enter a pause state, so that the first player 31 pauses playing the first video. The first video is played by the second device 22, thereby saving the network traffic of the first device 21 and reducing the power consumption of the first device 21.

In another possible embodiment, after the first device 21 projects the first video currently played in the first player 31 to the second device 22, the first device 21 may control the first player 31 to continue playing the first video, that is, the first device 21 and the second device 22 may play the first video synchronously.

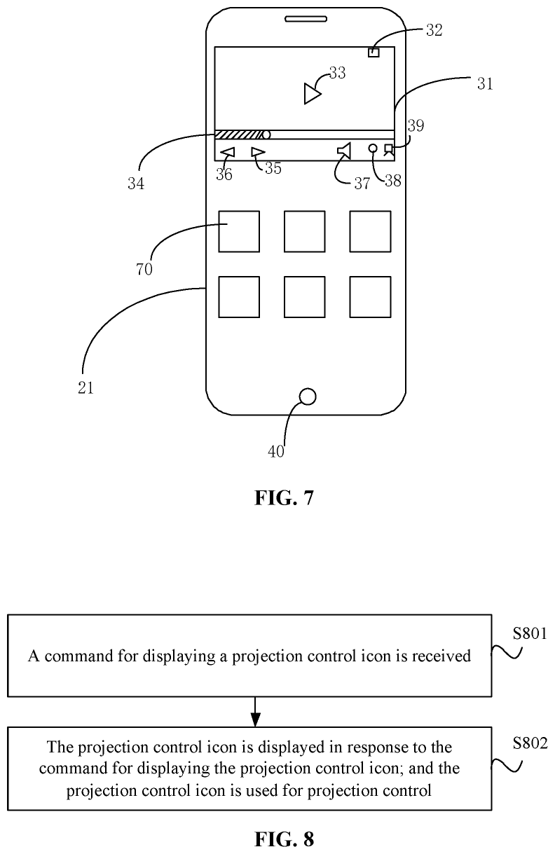

When the first player 31 pauses playing, the first device 21 enters a projection control page. The projection control page may specifically be a user interface as shown in FIG. 7. As shown in FIG. 7, the first player 31 pauses playing, and a pause sign 33 is displayed on the first player 31.

In S604, the playback progress of the first video is received from the target device.

The first device 21 may receive the playback progress of the first video from the second device 22 in real time. The first device 21 may update the playback progress of the first video in real time on the projection control page. As shown in FIG. 7, the progress bar 34 represents the playback progress of the first video. It can be understood that the playback progress of the first video may also be displayed on the second device 22. That is to say, the playback progress of the first video may be updated on the first device 21 and the second device 22 synchronously.

The user may control to fast forward or fast rewind the first video on the second device 22 by dragging the progress bar 34, so as to adjust the playback progress of the first video on the second device 22. The user may control to fast forward the first video on the second device 22 by long pressing the fast forward key 35, and control to fast rewind the first video on the second device 22 by long pressing the fast rewind key 36.

In some examples, when the user operates a progress control icon such as the progress bar 34 in the projection control page, a corresponding progress control command may be triggered. The first device 21 sends the progress control command to the second device 22. Upon receiving the progress control command, the second device 22 may control the playback progress of the first video according to the progress control command.

It should be noted that icons for controlling the playback progress in the projection control page are not limited to the progress bar 34, the fast forward key 35 and the fast rewind key 36 as shown in FIG. 7, which may also include other icons.

The user may control the playback progress of the first video through a controller of the second device 22. For example, when the second device 22 is a TV, the controller may specifically be a remote control. The user may control the playback progress of the first video on the TV through the remote control.

The user may also control the playback volume of the first video on the projection control page. As shown in FIG. 7, when the user operates the volume control icon 37, a volume control command may be triggered. The first device 21 sends the volume control command to the second device 22, so that the second device 22 can adjust the playback volume of the first video. The user may also control the playback volume of the first video through the controller of the second device 22.

It should be noted that icons for controlling the playback volume in the projection control page are not limited to the volume control icon 37 shown in FIG. 7, but may also include other icons. For example, the projection control page may display “+” and “−”. When the user long presses “+” or “−”, a playback volume adjustment command may be triggered. When receiving the playback volume adjustment command, the first device 21 adjusts the playback volume of the first video in the second device 22 according to the playback volume adjustment command. “+” is used to increase the playback volume, and “−” is used to decrease the playback volume. If the first device 21 is a mobile phone, the user may trigger a playback volume adjustment command through a volume adjustment button of the mobile phone, so as to adjust the playback volume of the first video in the second device 22.

It should be noted that the user may control the pause of the first video through the controller of the second device 22. For example, the second device 22 is a TV, and the controller of the second device 22 is a remote control. The remote control includes a pause button. A video pause control command may be triggered when the user presses the pause button. Then, the remote controller sends the video pause control command to the second device 22, and the second device 22 controls the pause of the first video according to the video pause control command.

The user may adjust the definition of the first video on the second device 22 through the resolution control icon 38 on the projection control page. For example, when the user operates the resolution control icon 38, a resolution selection pop-up window may pop up in the projection control page. The resolution selection pop-up window may include multiple resolution modes. The user may select one of the resolution modes. Specifically, when the user selects a certain resolution mode, a resolution configuration command may be triggered. The first device 21 sends the resolution configuration command to the second device 22, and the second device 22 may configure the resolution of the first video displayed on the second device 22 according to the resolution mode instructed in the resolution configuration command, so as to realize the adjustment of the definition of the first video on the second device 22.

In some embodiments, the video application program may have a function of changing the projectable device. For example, when the user needs to replace the second device 22 with another device, the user may click a device replacement icon 39. At this time, the first device 21 may enter a device search page. The device search page may be specifically the projection guide page as described above. The projection guide page includes identifications of multiple projectable devices. The user may select other projectable device other than the second device 22, as a new second device. After the user clicks to close the device search page, the first device 21 may return to the projection control page shown in FIG. 7.

It should be noted that the user interface shown in FIG. 7 is only a schematic illustration, and the shape and position of each icon are not limited in the present embodiment.

In S605, when the playback progress of the first video is greater than or equal to a preset progress, video information of a second video is acquired.

When the playback progress of the first video is greater than or equal to the preset progress, the first device 21 may acquire the video information of the second video. For example, the video information of the second video may be a video address (e.g., a URL) of the second video, or may be video data of the second video.

In S606, when the projection of the first video is completed, the video information of the second video is sent to the target device. The target device is configured to acquire the second video according to the video information of the second video, and play the second video.

Taking the video information of the second video as the video address of the second video as an example, the first device 21 sends the video address of the second video to the second device 22 when the projection of the first video is completed. The second device 22 may acquire video data of the second video from the server 24 according to the video address of the second video, and play the second video.

In some embodiments, the video information of the second video further includes at least one of a playback progress of the second video, a resolution of the second video, and a playback volume of the second video.

The server 23 may determine the ratio of each part of the head part, the plot part and the end part of each episode of the TV drama to the episode. The server 23 may send to the first device 21 time stamp information or the ratio information of each part of the head part, plot part and end part of each episode of the TV drama to the episode.

As described in the foregoing embodiment, when the playback progress of the first video on the second device 22 reaches 95%, the first device may determine that the projection of the first video is completed. The first device 21 sends video information of the second video to the second device 22. The video information of the second video includes not only the video address of the second video, but also the playback progress of the second video. For example, the playback progress of the second video may be an initial playback progress of the second video. The initial playback progress may be a playback progress when the head part of the projected video is fully played. Taking the projected video as the second video as an example, the initial playback progress of the second video may be the ratio of the head part of the second video to the second video. For example, the initial playback progress of the second video may be 5%. That is, the second device 22 may play the second video from the playback progress 5% of the second video. In this way, when the second device 22 plays the second video from 5% of the second video, the head part of the second video may be skipped. Thus, the user does not need to watch the repeated part of episodes of the TV drama multiple times, which improves the user experience.

The video information of the second video sent from the first device 21 to the second device 22 may further include the resolution of the second video. The second device 22 can adjust the resolution of the second video on the second device 22 according to the resolution of the second video.

In an embodiment, after the first device 21 controls the first player in the projection application program of the first device 21 to enter a pause state, the method further includes the following steps. The first device 21 receives a projection stop command, and controls the first player in the projection application program of the projection device to enter the playback state in response to the projection stop command.

When the first device 21 or the video application program is in the projection state, the user may control the first device 21 or the video application program to exit the projection state. As shown in FIG. 7, when the user operates the projection button 32 again, a projection stop command may be triggered. That is to say, the projection button 32 may be a projection control switch. In the non-projection state, the user may click the projection button 32 once to control the first device 21 or the video application program to enter the projection state. In the projection state, the user may click the projection button 32 once to control the first device 21 or the video application program to exit the projection state.

For example, in the non-projection state, when the user clicks the projection button 32 once, the first device 21 may control the first device 21 or the video application program to enter the projection state. The video played on the first device 21 may be projected onto the second device 22 for playback. Taking the video played on the first device 21 as the first video as an example, the first device 21 controls the first device 21 to enter the projection state, in the case that the playback progress of the first video on the first device 21 reaches 40% when the user operates the projection button 32. Next, the first device 21 sends the video information of the first video to the second device 22. The video information of the first video may include the video address of the first video and the playback progress of the first video (e.g., 40%). As such, the second device 22 may acquire the video data of the first video according to the video address of the first video, and continue to play the first video from 40% of the first video according to the playback progress of the first video. In this way, rather than repeatedly re-watching the already watched part from 0% of the first video on the second device 22, the user directly watching the unwatched part, thereby saving user time and improving user experience.

Next, the user may trigger the projection stop command. For example, when the user clicks the projection button 32 again, a projection stop command may be triggered. When the first device 21 receives the projection stop command, the first device 21 may control the first player in the first device 21 to enter the playback state. The projected video played on the second device 22 may be resumed to the first device 21 for continuous playback. In some embodiments, when the first video is played on the second device 22 and when the playback progress of the first video on the second device 22 is 50%, the user turns off the projection function, and the first device 21 continues to play the first video from 50% of the first video. When the projection on the second device 22 is stopped, the first device 21 continues to play the projected video on the second device, from the playback progress when the projection of the second device 22 ends. In this way, rather than re-watching the repeated part that has been played on the second device from 40% of the first video on the first device 21, the user may directly watch from the unwatched part, for example, from 50% of the first video, thereby saving user time and improving user experience. The method can realize the relay playing of the first video between the first device 21 and the second device 22, thereby ensuring that the first video can be played continuously and uninterruptedly, improving the user's experience of watching the video and improving the user's satisfaction. In some embodiments, the user may click a back button on the remote control of the second device 22 to control the second device 22 to exit the projection state. The first video played on the second device 22 may be resumed to the first device 21 for continuous playback, which ensures that the first video can be played continuously and uninterruptedly, and improves the user's experience of watching the video.

In the video projection method according to the embodiments of the present disclosure, the first device 21 monitors the playback progress of the previous video played on the second device in real time through the first device 21. In the case that the playback progress of the previous video reaches a playback progress when the second device starts to play the end part of the previous video, it is determined that the projection of the previous video on the second device is completed. The first device 21 sends the video information of the next video to the second device, so that the second device starts to play the next video. In this way, the second device can skip the end part of the previous video. The user does not need to watch the end part repeatedly, which saves user time and improves user experience.

Further, when the previous video on the second device 22 is fully played, the first device 21 sends to the second device 22 the video information such as the playback progress and the video address of the next video. Rather than playing the next video from the starting point (e.g., the playback progress is 0%) of the next video, the second device 22 may start to play from the playback progress (e.g., 5%) of the next video. Thus, the second device 22 can skip the head part of the next video. Furthermore, the user does not need to repeatedly watch the repeated part of multiple videos, which saves the user's time and improves the user experience.

Further, when the first device 21 is in a non-projection state, the first device 21 sends to the second device 22 the video information such as the playback progress and video address of the current video currently played on the first device 21. Thus, the second device 22 may start to play the current video directly from the playback progress of the current video according to the playback progress and the video address of the current video. The user does not need to watch the current video on the second device 22 from the beginning. When the first device 21 is in the projection state, the first device 21 sends a projection command of the next video to the second device when the current video on the first device 21 is not fully played. The second device 22 starts to play the next video when the playback of the current video is not completed by the second device 22. As such, the second device 22 does not need to play the end part of the current video. Moreover, the first device 21 sends the initial playback progress of the next video to the second device 22. Thus, the second device 22 does not need to play content prior to the initial playback progress of the next video, such as the head part, thereby saving user's time. Moreover, the user can watch more videos, which further improves the user experience.

In an embodiment, the method further includes the following steps. When the first device 21 determines that the projection of the first video is completed, the first player of the projection application program of the first device 21 is closed, and the first device 21 restarts the first player.

The first device 21 projects the first video currently played in the first player 31 to the second device 22 for playback. When the projection of the first video is completed, the first player 31 may be automatically closed.

In some embodiments, when the projection of the first video is completed, the first device 21 may detect whether the first player 31 is closed. If the first player 31 is closed, the first device 21 may restart the first player 31 and enable the first player 31 in a pause state.

In the video projection method according to the embodiments of the present disclosure, after detecting that the first player is closed, the first device 21 restarts the first player. As such, it can be ensured that the first device 21 can normally project a subsequent video to the second device 22, which reduces interruptions in the projection process and reduces the times the user performs manual projection operations. Thus, the convenience of the first device used by the user to project the video to the second device, and user experience are improved.

In combination with the above embodiments, when the first video is played on the first player 31 of the video application program of the first device 21, the method may further include the following steps S801 and S802 as shown in FIG. 8.

In S801, a command for displaying a projection control icon is received.

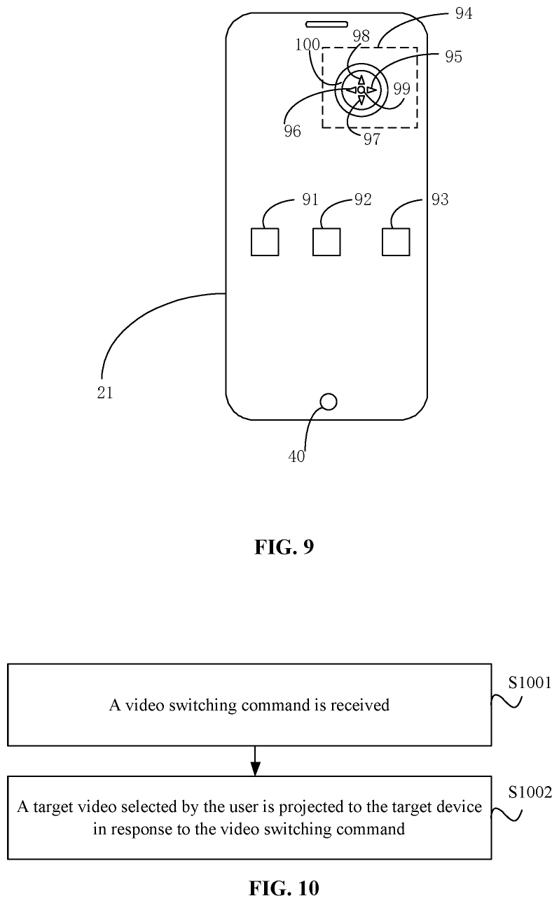

The user interface shown in FIG. 7 may further include a preset icon. When the user clicks on the preset icon, a command for displaying a projection control icon may be triggered. When the first device 21 receives the command for displaying the projection control icon, the projection control icon may be displayed on the user interface. The projection control icon may specifically be the projection control icon 94 shown in FIG. 9. The user may perform projection control through the projection control icon.

In an embodiment, when the display condition of the projection control icon is satisfied, the first device 21 receives a command for displaying a projection control icon. The display condition of the projection control icon 94 may include a preset condition. As an example, the preset condition may be that the projection application program of the first device 21 transforms from a front-end running state to a background running state. In this case, when the first device 21 detects that the projection application program transforms from the front-end running state to the background running state, the display condition is satisfied, and the first device 21 receives the command for displaying the projection control icon.

The user interface shown in FIG. 7 is a user interface provided by the video application program. In some application scenarios, the user may control the video application program to enter the background running mode. In some possible implementations, when the user needs to open other application program on the first device 21, the user may click a return button 40 as shown in FIG. 7 to make the projection application program on the first device 21 transform from the front-end running state to the background running state. For example, the first device 21 may return to the desktop interface. The desktop interface may include icons of multiple application programs. The user may trigger other application program in the first device 21 by clicking on the icon of other application program, so that the user can use other application program.

In some embodiments, the user may trigger a background running command by operating the return button 40. When receiving the background running command, the first device 21 may control the video application program to run in the background.

In S802, the projection control icon is displayed in response to the command for displaying the projection control icon. The projection control icon is used for projection control.

In some embodiments, the first device 21 displays a projection control icon on the desktop interface of the first device 21 after detecting that the video application program transforms from the front-end running state to the background running state. The projection control icon is used for projection control. In some possible embodiments, the user may switch the video projected to the second device through the projection control icon. For example, the user may switch, through the project control icon, the video project to the second device to be the target video. The target video may be selected by the user. In some other possible embodiments, the user may also control the playback progress, playback volume, resolution or the like of the projected video played on the second device 22 through the projection control icon.

As shown in FIGS. 9, 91 to 93 respectively represent icons of application programs, and 94 represents a projection control icon. The projection control icon 94 may include multiple sub-icons, and different sub-icons may implement different control functions. Specifically, the sub-icon 95 and the sub-icon 96 may be used to control the playback progress of the projected video. The projected video refers to the video being projected and displayed on the second device. For example, the user may trigger a playback progress control command by operating the sub-icon 95 or the sub-icon 96. The first device 21 sends the playback progress control command to the second device 22, and the second device 22 controls the playback progress of the projected video on the second device 22 according to the playback progress control command. Sub-icon 97 and sub-icon 98 may be used to switch the projected video. The user may trigger a video switching command by operating the sub-icon 97 or the sub-icon 98. The first device 21 sends the video switching command to the second device 22. The video switching command includes the video information of the target video in the video information list. For example, the video information of the target video may be video information of a next video, or may be video information of a previous video, or may be video information of other video. As such, the second device 22 plays the target video according to the video information of the target video.

The sub-icon 99 may be used to adjust the resolution of the projected video. In some possible embodiments, the user may trigger a resolution configuration command by operating the sub-icon 99. The first device 21 sends the resolution configuration command to the second device 22. The second device 22 may control the resolution of the projected video played on the second device according to the resolution configuration command. The sub-icon 100 may be used to control the playback volume of the projected video. For example, the user may trigger a playback volume control command by operating the sub-icon 100. The first device 21 sends the playback volume control command to the second device 22. The second device 22 can control the playback volume of the projected video played on the second device 22 according to the playback volume control command.

The sub-icon 95 is used to control the fast-forward of the projected video played on the second device 22. The sub-icon 96 is used to control the fast-rewind of the projected video played on the second device 22. The sub-icon 97 is used to switch the video projected to the second device to a next video of the projected video. The sub-icon 98 is used to switch the video projected to the second device to a previous video of the projected video. The sub-icon 100 may be rotated. When the sub-icon 100 is rotated counterclockwise, the playback volume of the projected video played on the second device 22 is controlled to increase. When the sub-icon 100 is rotated clockwise, the playback volume of the project video played on the second device 22 is controlled to decrease. Similarly, the user may trigger a playback progress control command by operating the sub-icon 95 or the sub-icon 96. The first device 21 sends the playback progress control command to the second device 22. The second device 22 can controls the playback progress of the projected video played on the second device 22 according to the playback progress control command. The user may trigger a video switching command by operating the sub-icon 97 or the sub-icon 98. The first device 21 sends the video switching command to the second device 22. The video switching command includes the video information of the next video or the video information of the previous video in the video information list, so that the second device 22 plays the next video or the previous video according to the video information of the next video or the video information of the previous video.

It should be noted that the projection control icon 94 shown in FIG. 9 is only a schematic illustration. The projection control method through the projection control icon 94 is not limited to the method described above. In addition, some sub-icons of the projection control icon 94 shown in FIG. 9 may have multiple usages. For example, the user may control the fast-forward of the projected video on the second device by a single click of the sub-icon 95. The user may control the volume of the projected video to increase by a double click of the sub-icon 95. For example, the user may trigger a playback progress control command by a single click of the sub-icon 95, and the first device 21 sends the playback progress control command to the second device 22, so that the second device 22 controls the playback progress of the projected video played on the second device 22 according to the playback progress control command. The user may trigger a playback volume control command by double-click of the sub-icon 95, and the first device 21 sends the playback volume control command to the second device 22, so that the second device 22 controls the playback volume of the projected video played on the second device 22 according to the playback volume control command.

It should be noted that when the first device 21 is in the projection state and the projection control page is not currently displayed on the first device 21, the projection control icon 94 may be displayed globally. For example, when the first device 21 activates other application program, the first device 21 may display a user interface of other application program, and display the projection control icon 94 on the user interface of other application program in a transparent, semi-transparent or floating manner. In this way, the user can control the video projection while controlling other application program.

In addition, the user may also control the video application program to run in the front-end, in replacement of running in the background, by operating the projection control icon 94. When the video application program is run in the front end, the user interface of the first device 21 may return to the user interface shown in FIG. 7. The specific operation of the user on the projection control icon 94 is not limited in this embodiment, as long as the first device 21 can distinguish the user's operation on the sub-icons in the projection control icon 94 from the operation on the projection control icon 94.

In some embodiments, the display position of the projection control icon 94 on the first device 21 may be fixed or not fixed. For example, the user may drag the projection control icon 94 to change the display position of the projection control icon 94.

In the video projection method according to the embodiment of the present disclosure, the first device 21 runs a video application program in the background in response to a background running command of the user, and displays a projection control icon on the user interface of the first device 21. The projection control icon is used for projection control. Even when the first device 21 transforms the video application program in the front-end running state to the background running state, the user can still control the video projection of the video application program through the projection control icon. In this way, the user can control the video projection while controlling other application program, which further improves the convenience of the user controlling on video projection.

On the basis of the foregoing embodiments, the method may further include the following steps S1001 and S1002 as shown in FIG. 10.

In S1001, a video switching command is received.

In this embodiment, the user may switch the video projected to the second device at any time. For example, the projected video currently projected from the first device 21 to the second device 22 for playback is the second video as described above. During the playback of the second video on the second device 22, the user may trigger the video switching command by clicking thumbnails of other videos on the user interface as shown in FIG. 7, or by clicking the sub-icon 97 or sub-icon 98 as shown in FIG. 9. For example, the user may trigger a video switching command by an operation of clicking the thumbnails of other videos, or the user may trigger a video switching command by an operation of clicking the sub-icon 97 or the sub-icon 98.

In S1002, a target video selected by the user is projected to the target device in response to the video switching command.

After receiving the video switching command, the first device 21 sends a third projection command to the second device 22. The third projection command includes video information of the target video selected by the user, and the third projection command is used to control the second device 22 to play the target video according to the video information of the target video. For example, the video information of the target video includes video data of the target video or a video address of the target video. As described above, the projected video currently played by the second device 22 is the second video. In response to a reception of the third projection command, the second device 22 stops playing the second video. In addition, the second device 22 plays the target video according to the video data of the target video sent by the first device 21, or acquires the video data of the target video according to the video address of the target video and plays the target video.

In a possible embodiment, in response to a reception of the third projection command, the second device 22 may directly play the target video according to the video information of the target video. For example, the second device 22 may project and display the target video.

In another possible embodiment, the third projection command is used to control the second device 22 to turn on the second player. For example, after receiving the third projection command, the second device 22 may activate the player in the second device 22 according to the third projection command. The player in the second device 22 may be recorded as the second player. Further, the second device 22 may control the second player in the second device 22 to play the target video according to the video information of the target video.

For example, if the second video is currently playing on the second device 22 and the user clicks the thumbnail 70 shown in FIG. 7, the first device 21 may send the video information of the video corresponding to the thumbnail 70 to the second device 22, such that the second device 22 plays the video corresponding to the thumbnail 70. If the user clicks the sub-icon 97, the first device 21 may send to the second device 22 the video information of the next video of the second video, such that the second device 22 plays the next video of the second video. If the user clicks the sub-icon 98, the first device 21 may send to the second device 22 the video information of the previous video of the second video, such that the second device 22 plays the previous video of the second video. The next video of the second video or the previous video of the second video may be specifically determined according to the above video information list. The ordering of the video information in the video information list may represent the ordering of videos.

As can be seen from the above embodiment, the user may control turn-on or turn-off of the projection function by operating the projection button 32. In this embodiment, if the video currently played by the second device 22 is projected from the first device 21, the first device 21 may default the switched video also to be projected to the second device 22.

In an embodiment, upon receiving the video switching command, the first device detects whether the projection application program is in the projection state. When the projection application program is in the projection state, the first device 21 projects the target video selected by the user to the second device 22.

The user can control turn-on or turn-off of the projection function by operating the projection button 32 at any time. Thus, when receiving the video switching command triggered by the user, the first device 21 may detect whether the video application program is currently in the projection state. If the video application program is currently in the projection state, the first device 21 may directly send to the second device 22 the video information of the target video selected by the user, according to the video switching command. Thus, the second device 22 plays the target video according to the video information of the target video. If the video application program is not currently in the projection state, the first device 21 may normally play the target video selected by the user through the first player 31. The specific determination process is shown in FIG. 11. As shown in FIG. 11, the process specifically includes the following steps S1101 to S1103.

In S1101, a video switching command is received.

In S1102, it is determined whether the video application program is currently in a projection state. S1103 is performed if the video application program is currently in a projection state; otherwise, S1104 is performed.

In S1103, a new video directly enters the projection state.

The new video may be the target video selected by the user. The new video directly entering the projection state may specifically mean that the first device 21 directly projects the new video to the second device 22 for playback. After the first device 21 directly projects the new video to the second device 22 for playback, the process of updating the video information list and acquiring the video information of the next video from the video information list is similar to the above embodiments, which will not be repeated here.

In S1104, the new video is played in a normal state.

In an embodiment, projection parameters of the target video are the same as projection parameters of historical projected videos. The second device may store the projection parameters of the historical projected videos. The historical projected video may be the first video or the second video as described above. The projection parameters include at least one of playback progress, resolution and playback volume.

If the third projection command sent from the first device 21 to the second device 22 does not include the projection parameters of the target video selected by the user, the second device 22 may play the target video according to the projection parameters of the historical projected videos. In an embodiment, the resolution of the target video is consistent with the resolution of the video projected to the second device before switch; and/or the playback volume of the target video is the same as the playback volume of the video projected to the second device before switch. For example, the second device 22 plays the target video according to the projection parameters used when playing the second video. For example, if the second device 22 plays the second video in high definition and with the playing volume of 6, the second device 22 plays the target video in high definition and with the playing volume of 6.

It should be noted that the target video selected by the user may be any video in a video set. This video set is a complete TV drama. The second device 22 may continuously play videos in the video set. When the second device 22 plays the last video in the video collection, the second device may restart the playback from the first video in the video set after the last video is fully played.

In some embodiments, since the first player 31 occupies a small area when the first device 21 is in a portrait mode, the user interface of the first device 21 may display multiple video icons of the video set. At this time, the user may click any one of video icons in the video set to switch the projected video. Since the first player 31 occupies a large area when the first device 21 is in a landscape mode, the video icons of the video set may not be displayed. In this case, a “selection” icon may be displayed on the user interface of the first device 21. When the user clicks the “selection” icon, multiple video icons of the video set may be displayed on the user interface. The user may click any one of the video icons to switch the projected video.

In the video projection method according to the embodiment of the present disclosure, the first device 21 detects whether the video application program is in the projection state according to the video switching command. If the video application program is in the projection state, the video information of the target video selected by the user is sent to the second device 22, such that the second device 22 plays the target video. If the video application program is not in the projection state, the first device 21 plays the target video through the first player 31 of the first device 21, rather than controlling the second device 22 to play the target video. The first device 21 detects whether the video application program is in the projection state before projecting the video, and directly projects the video if the video application program is in the projection state. If the video application program is not in the projection state, the projection is not performed, so as to avoid wrong operations that the first device 21 continues the video projection after the user turns off the projection function of the projection device. In this way, the correctness of the video projection is ensured. Moreover, it is also ensured that videos can be continuously projected to and played by the second device after the user performs a projection operation once, without repeatedly performing the projection operation.

In addition, the projection parameters of the target video selected by the user are consistent with the projection parameters of the projected video played on the second device before switch, which reduces the times the user configures the projection parameters of the target video. The user does not need to reconfigure the projection parameters of the switched target video, and the second device can play the target video according to the user's habit, which meets the user's requirements, and further saves the user's time and improves the user experience.

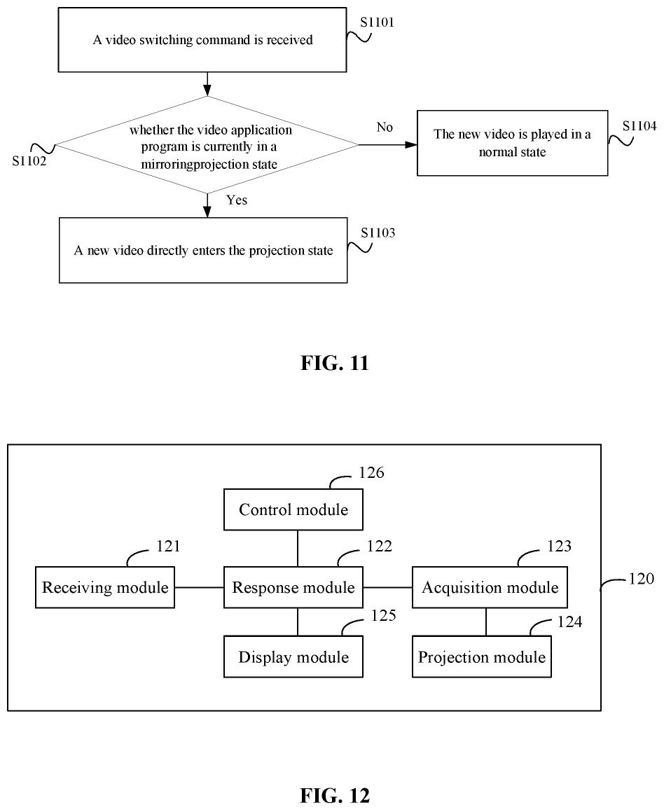

FIG. 12 is a schematic structural diagram of a video projection apparatus according to an embodiment of the disclosure. The video projection apparatus according to an embodiment of the present disclosure may be configured in a client. The video projection apparatus 120 specifically includes the following modules: a receiving module 121, a response module 122, an acquisition module 123, and a projection module 124.

The receiving module 121 is configured to receive a start projection command.

The response module 122 is configured to project a first video to a second device in response to the start projection command.

The acquisition module 123 is configured to acquire a playback progress of the first video on the second device.

The projection module 124 is configured to determine that a projection of the first video is completed according to the playback progress of the first video on the second device; and project a second video to the second device, in response to a determination of the projection of the first video being completed.

In an embodiment, the projection module 124 is specifically configured to determine that the projection of the first video is completed, in the case that the playback progress of the first video on the second device reaches a preset progress.

In an embodiment, a projected video played on the second device includes a head part, a plot part and an end part which are played in sequence.

The preset progress is a playback progress when a playback of the plot part of the projected video is completed.

Alternatively, the preset progress is a playback progress when a playback of the end part of the projected video is completed.

In an embodiment, the response module 122 is specifically configured to: send a first projection command to the second device according to the start projection command. The first projection command includes video information of the first video, and the first projection command is used to control the second device to play the first video according to the video information of the first video.

In an embodiment, the video information of the first video includes a playback progress of the first video on the first device. The first projection command is specifically used to control the second device to play the first video from the playback progress of the first video on the first device.

In an embodiment, the receiving module 121 is further configured to receive a stop projection command.

The acquisition module 123 is further configured to acquire the playback progress of the first video on the second device. The stop projection command is used to control the first device to play the first video from the playback progress of the first video on the second device.

In an embodiment, the projection module 124 is specifically configured to: send a second projection command to the second device, in response to determining that the projection of the first video is completed according to the playback progress of the first video on the second device. The second projection command includes video information of the second video, and the second projection command is used to control the second device to play the second video according to the video information of the second video.

In an embodiment, the projection module 124 is specifically configured to: acquire the video information of the second video, and send a second projection command to the second device according to the video information of the second video, in response to determining that the projection of the first video is completed according to the playback progress of the first video on the second device.

In an embodiment, the projection module 124 is specifically configured to: acquire the video information of the second video from a video information list; or, acquire the video information of the second video from a server.

In an embodiment, the acquisition module 123 is specifically configured to: receive the playback progress of the first video on the second device from the second device.

In an embodiment, the video projection apparatus 120 further includes: a display module 125. The receiving module 121 is further configured to: receive a command for displaying a projection control icon. The display module 125 is configured to display the projection control icon in response to the command for displaying the projection control icon. The projection control icon is used for projection control.

In an embodiment, the receiving module 121 is specifically configured to: receive the command for displaying the projection control icon in the case that a display condition of the projection control icon is satisfied.

In an embodiment, the display condition of the projection control icon includes a condition that the projection application program of the first device transforms from a front-end running state to a background running state.

In an embodiment, the projection control icon is specifically configured to: switch the video projected to the second device; and/or, control one or more of a playback progress, a playback volume, and a resolution of the projected video played on the second device.

In an embodiment, the receiving module 121 is further configured to: receive a video switching command. The response module 122 is further configured to: project a target video selected by the user to the second device in response to the video switching command.

In an embodiment, the response module 122 is specifically configured to:
acquire a state of the projection application program in response to the video switching command; and
project the target video selected by the user to the second device in the case that the projection application program is in a projection state.

In an embodiment, the response module 122 is specifically configured to: send a third projection command to the second device. The third projection command includes video information of the target video selected by the user. The third projection command is used to: control the second device to play the target video according to the video information of the target video.

In an embodiment, the video information includes at least one of video data and a video address.

In an embodiment, in the case that the video information includes the video address, the second device is configured to acquire, according to the video address, video data corresponding to the video address.

In an embodiment, the video information further includes a projection parameter. The projection parameter includes at least one of a playback progress, a resolution and a playback volume.

In an embodiment, the projection parameter of the target video is consistent with a projection parameter of a historical projected video.

In an embodiment, the video projection apparatus 120 further includes: a control module 126 configured to control a first player of the projection application program to enter a pause state, after the first video is projected to the second device or after the second video is projected to the second device.

In an embodiment, the receiving module 121 is further configured to: receive a stop projection command. The response module 122 is further configured to: control the first player to enter a playback state in response to the stop projection command.

In an embodiment, the control module 126 is further configured to reactivate the first player when the projection of the first video is completed and the first player of the projection application program of the first device is turned off.

In an embodiment, the first projection command is further used to control a second player in the second device to be turned on to play the first video.

In an embodiment, the second projection command is further used to control the second player in the second device to be turned on to play the second video.

In an embodiment, the third projection command is further used to control the second player in the second device to be turned on to play the target video.

The video projection apparatus according to the embodiments of the present disclosure can execute steps performed by the client in the video projection method according to the method embodiments of the present disclosure, and the execution steps and beneficial effects thereof are not repeated herein.

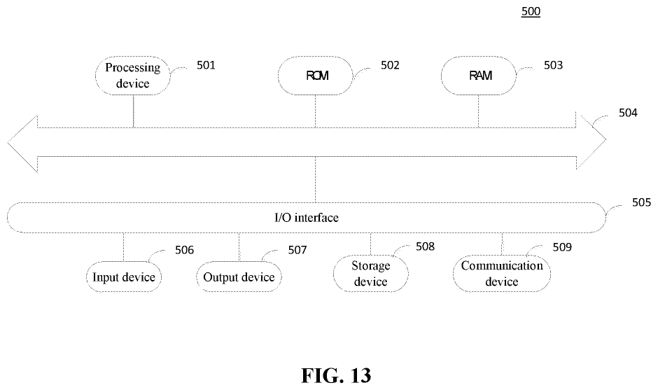

FIG. 13 is a schematic structural diagram of an electronic device according to an embodiment of the present disclosure. Hereinafter reference is made to FIG. 13 which shows a schematic structural diagram of an electronic device 500 suitable for implementing the embodiments of the present disclosure. The electronic device 500 in the embodiments of the present disclosure may include, but not limited to, mobile terminals such as a mobile phone, a notebook computer, a digital broadcast receiver, a personal digital assistance (PDA), a tablet computer (PAD), a portable multi-media player (PMP) and a vehicle terminal (such as a vehicle navigation terminal); and fixed terminals such as digital TV and a desktop computer.

The electronic device shown in FIG. 13 is exemplary, and is not intended to limit the function and scope of the embodiments of the present disclosure.

As shown in FIG. 13, the electronic device 500 may include a processing apparatus (such as a central processor and a graphic processor) 501. The processing apparatus may perform various appropriate actions and processing by executing programs stored in a read-only memory (ROM) 502 or programs uploaded from a storage apparatus 508 to a random access memory (RAM) 503. Various programs and data required for operations of the electronic device 500 are also stored in the RAM 503. The processing apparatus 501, the ROM 502 and the RAM 503 are connected to each other through the bus 504. An input/output (I/O) interface 505 is also connected to the bus 504.

Generally, the following components are connected to the I/O interface 505: an input apparatus 506 such as a touch screen, a touch panel, a keyboard, a mouse, a camera, a microphone, an accelerometer, and gyroscope; an output apparatus 507 such as a liquid crystal display (LCD), a loudspeaker and a vibrator; a storage apparatus 508 such as a magnetic tape and a hard disk; and a communication apparatus 509. The communication apparatus 509 may allow the electronic device 500 to communicate with other device in a wired or wireless manner to exchange data. Although FIG. 13 shows the electronic device 500 provided with various apparatuses, it should be understood that not all shown apparatuses are necessary. Alternatively, more or less apparatuses may be included.

According to embodiments of the present disclosure, a process described in the flowchart above may be implemented by computer software programs. For example, according to an embodiment of the present disclosure, a computer program product including computer program carried on a non-transitory computer readable medium is provided. The computer program includes program codes for performing the method shown in the flowchart. In such embodiment, the computer program may be downloaded and installed from the network through the communication apparatus 509, installed from the storage apparatus 508 or installed from the ROM 502. The computer program is executed by the processing apparatus 501 to perform functions defined in the methods described in the embodiments of the present disclosure.

It should be noted that, the computer readable medium described in the present disclosure may be a computer readable signal medium, a computer readable storage medium or any combination thereof. The computer readable storage medium may include but not limited to a system, an apparatus or a device in an electric, magnetic, optical, electromagnetic, infrared or a semiconductor form, or any combination thereof. The computer readable storage medium may include but not limited to electric connection of one or more wires, a portable computer magnetic disk, a hard disk, a random access memory (RAM), a read-only memory (ROM), an erasable programmable read only memory (EPROM or a flash memory), an optical fiber, a portable compact disk read only memory (CD-ROM), an optical storage device, a magnetic storage device or any combination thereof. In the present disclosure, the computer readable storage medium may be a tangible medium including or storing programs. The programs may be used by an instruction execution system, apparatus or device, or may be used in combination with the instruction execution system, apparatus or device. In the present disclosure, a computer readable signal medium may include a data signal in a baseband or propagated as a part of carrier. The computer readable signal medium carries computer readable program codes. The propagated data signal may include but not limited to an electromagnetic signal, an optical signal or any combination thereof. The computer readable signal medium may be any computer readable medium other than the computer readable storage medium. The computer readable signal medium may send, propagate or transmit programs used by the instruction execution system, apparatus or device or the programs used in combination with the instruction execution system, apparatus or device. The program code embodied in the computer readable medium may be transmitted via any appropriate medium, including but not limited to an electric wire, an optical fiber, radio frequency (RF) or any appropriate combination thereof.

In some embodiments, the client and the server may perform communication by using any known network protocol such as Hyper Text Transfer Protocol (HTTP) or any network protocol to be developed, and may connect with digital data in any form or carried in any medium (for example, a communication network). The communication network includes a local area network (LAN), a wide area network (WAN), an international network (for example the internet), a peer-to-peer network (for example ad hoc peer-to-peer network), and any known network or network to be developed.

The computer readable storage medium may be included in the electronic device, or the computer readable storage medium may be independent from the electronic device, i.e., not being installed in the electronic device.

The computer readable medium carries one or more programs. When executing the one or more programs, the electronic device is instructed to perform the following operations: acquiring a start projection command; projecting a first video to a second device in response to the start projection command; acquiring a playback progress of the first video on the second device; and projecting a second video to the second device, in response to determining that the projection of the first video is completed according to the playback progress of the first video on the second device.

Computer program codes for performing operations of the present disclosure may be written by using one or more program design language or any combination. The program design language includes but not limited to object oriented program design language such as Java, Smalltalk and C++, and further includes conventional process-type program design language such as “C” or similar program design language. The program codes may be completely or partially executed on a user computer, performed as an independent software packet, partially executed on the user computer and partially executed on a remote computer, or completely executed on the remote computer or a server. In a case of involving the remote computer, the remote computer may connect to the user computer via any type of network such as a local area network (LAN) and a wide area network (WAN). Alternatively, the remote computer may connect to an external computer (such as achieving internet connection by services provided by the internet network service provider).

The flowcharts and block diagrams shown in the drawings show a system architecture, function and operation which may be implemented by the system, method and computer program product according to the embodiments of the present disclosure. Each block in the flowcharts or the block diagram may represent a part of a module, a program section or codes including executable instruction(s) for implementing specified logic functions. It should be noted that, in alternative embodiment, functions denoted in the blocks may be performed in an order different from the order denoted in the drawing. For example, operations in two blocks connected successively may be performed in parallel, or may be performed in an opposite order, depending on the involved function. It should be noted that, each block in the block diagrams and/or flowcharts, and a combination of blocks in the block diagrams and/or flowcharts may be implemented by a dedicated hardware-based system for performing specified functions or operations, or may be implemented by a combination of dedicated hardware and computer instructions.

Units involved in the embodiments of the present disclosure may be implemented by software or hardware. Names of the units do not limit the units in a certain case.

The functions described above herein may be partially performed by one or more hardware logic components. For example, the hardware logic components may include but not limited to: a field programmable gate array (FPGA), an application specific integrated circuit (ASIC), an application specific standard product (ASSP), a system on chip (SOC), a complex programmable logic device (CPLD) and so on.

It the context of the present disclosure, the machine readable medium may be a tangible medium including or storing programs. The programs may be used by an instruction execution system, apparatus or device, or may be used in combination with the instruction execution system, apparatus or device. The machine readable medium may be a machine readable signal medium or a machine readable storage medium. The machine readable medium may include but not limited to a system, an apparatus or a device in an electric, magnetic, optical, electromagnetic, infrared or a semiconductor form, or any combination thereof. The machine readable storage medium may include but not limited to electric connection of one or more wires, a portable computer magnetic disk, a hard disk, a random access memory (RAM), a read-only memory (ROM), an erasable programmable read only memory (EPROM or a flash memory), an optical fiber, a portable compact disk read only memory (CD-ROM), an optical storage device, a magnetic storage device or any combination thereof.

According to one or more embodiments of the present disclosure, a video projection method is provided in the present disclosure provides. The method is applied to a first device, and includes:
receiving, by the first device, a start projection command;
projecting, by the first device, a first video to a second device in response to the start projection command;
acquiring, by the first device, a playback progress of the first video on the second device; and
determining, by the first device, that a projection of the first video is completed according to the playback progress of the first video on the second device; and projecting a second video to the second device, in response to a determination of the projection of the first video being completed.

According to one or more embodiments of the present disclosure, the determining, by the first device, that a projection of the first video is completed according to the playback progress of the first video on the second device includes:
determining that the projection of the first video is completed, in the case that the playback progress of the first video on the second device reaches a preset progress.

According to one or more embodiments of the present disclosure, a projected video played on the second device includes a head part, a plot part and an end part which are played in sequence;
the preset progress is a playback progress when a playback of the plot part of the projected video is completed, or
the preset progress is a playback progress when a playback of the end part of the projected video is completed.

According to one or more embodiments of the present disclosure, the projecting the first video to the second device includes:
sending, by the first device, a first projection command to the second device, where the first projection command includes video information of the first video, and the first projection command is used to control the second device to play the first video according to the video information of the first video.

According to one or more embodiments of the present disclosure, the video information of the first video includes a playback progress of the first video on the first device; the first projection command is used to control the second device to play the first video from the playback progress of the first video on the first device.

According to one or more embodiments of the present disclosure, the method further includes:
receiving, by the first device, a stop projection command; and
acquiring, by the first device, the playback progress of the first video on the second device, where the stop projection command is used to control the first device to play the first video from the playback progress of the first video on the second device.

According to one or more embodiments of the present disclosure, the determining, by the first device, that a projection of the first video is completed according to the playback progress of the first video on the second device; and projecting a second video to the second device, in response to a determination of the projection of the first video being completed includes:
sending, by the first device, a second projection command to the second device, in response to determining that the projection of the first video is completed according to the playback progress of the first video on the second device, where the second projection command includes video information of the second video, and the second projection command is used to control the second device to play the second video according to the video information of the second video.

According to one or more embodiments of the present disclosure, the sending, by the first device, a second projection command to the second device, in response to determining that the projection of the first video is completed according to the playback progress of the first video on the second device includes:
acquiring, by the first device, the video information of the second video; and
sending, by the first device, the second projection command to the second device according to the video information of the second video, in response to the determination of that the projection of the first video is completed according to the playback progress of the first video on the second device.

According to one or more embodiments of the present disclosure, the acquiring, by the first device, the video information of the second video includes:
acquiring, by the first device, the video information of the second video from a video information list; or
acquiring, by the first device, the video information of the second video from a server.

According to one or more embodiments of the present disclosure, the acquiring, by the first device, a playback progress of the first video on the second device includes:
receiving, by the first device, the playback progress of the first video on the second device from the second device.

According to one or more embodiments of the present disclosure, the method further includes:
receiving, by the first device, a command for displaying a projection control icon; and
displaying, by the first device, the projection control icon according to the command for displaying the projection control icon, where the projection control icon is used for projection control.

According to one or more embodiments of the present disclosure, the receiving, by the first device, the command for displaying the projection control icon includes:
receiving, by the first device, the command for displaying the projection control icon, in the case that a display condition of the projection control icon is satisfied.

According to one or more embodiments of the present disclosure, the display condition of the projection control icon includes a condition that a projection application program of the first device transforms from a front-end running state to a background running state.

According to one or more embodiments of the present disclosure, the projection control icon is specifically used to: switch a video projected to the second device; and/or
control one or more of a playback progress, playback volume, and resolution of the projected video played on the second device.

According to one or more embodiments of the present disclosure, the method further includes:
receiving, by the first device, a video switching command; and
projecting, by the first device, a target video selected by a user to the second device in response to the video switching command.

According to one or more embodiments of the present disclosure, the projecting, by the first device, the target video selected by the user to the second device according to the video switching command includes:
acquiring, by the first device, a state of the projection application program in response to the video switching command; and
projecting, by the first device, the target video selected by the user to the second device, in the case that the projection application program is in a projection state.

According to one or more embodiments of the present disclosure, the projecting the target video selected by the user to the second device includes:
sending, by the first device, a third projection command to the second device, where the third projection command includes video information of the target video selected by the user, and the third projection command is used to control the second device to play the target video according to the video information of the target video.

According to one or more embodiments of the present disclosure, the video information includes at least one of video data and a video address.

According to one or more embodiments of the present disclosure, in the case that the video information includes the video address, the second device is configured to acquire, according to the video address, video data corresponding to the video address.

According to one or more embodiments of the present disclosure, the video information further includes a projection parameters and
the projection parameter includes at least one of a playback progress, a resolution and a playback volume.

According to one or more embodiments of the present disclosure, the projection parameter of the target video is consistent with a projection parameter of a historical projected video.

According to one or more embodiments of the present disclosure, after projecting the first video to the second device or after projecting the second video to the second device, the method further includes:
controlling, by the first device, a first player in the projection application program to enter a pause state.

According to one or more embodiments of the present disclosure, after controlling, by the first device, a first player in the projection application program to enter a pause state, the method further includes:
receiving, by the first device, a stop projection command; and
controlling, by the first device, the first player to enter a playback state in response to the stop projection command.

According to one or more embodiments of the present disclosure, the method further includes:
reactivating, by the first device, the first player, when the projection of the first video is completed and the first player in the projection application program of the first device is turned off.

According to one or more embodiments of the present disclosure, the first projection command is further used to control a second player in the second device to be turned on, to play the first video.

According to one or more embodiments of the present disclosure, the second projection command is further used to control a second player in the second device to be turned on, to play the second video.

According to one or more embodiments of the present disclosure, the third projection command is further used to control a second player in the second device to be turned on, to play the target video.

According to one or more embodiments of the present disclosure, a video projection apparatus is provided in the present disclosure. The apparatus includes:
a receiving module configured to receive a start projection command;
a response module configured to project a first video to a second device in response to the start projection command;
an acquisition module configured to acquire a playback progress of the first video on the second device; and
a projection module configured to determine that a projection of the first video is completed according to the playback progress of the first video on the second device; and
project a second video to the second device, in response to a determination of the projection of the first video being completed.

According to one or more embodiments of the present disclosure, the projection module is specifically configured to determine that the projection of the first video is completed, in the case that the playback progress of the first video on the second device reaches a preset progress

According to one or more embodiments of the present disclosure, a projected video played on the second device includes a head part, a plot part and an end part which are played in sequence;
the preset progress is a playback progress when a playback of the plot part of the projected video is completed; or,
the preset progress is a playback progress when a playback of the end part of the projected video is completed.

According to one or more embodiments of the present disclosure, the response module is specifically configured to: send a first projection command to the second device according to the start projection command. The first projection command includes video information of the first video, and the first projection command is used to control the second device to play the first video according to the video information of the first video.

According to one or more embodiments of the present disclosure, the video information of the first video includes a playback progress of the first video on the first device. The first projection command is specifically used to control the second device to play the first video from the playback progress of the first video on the first device.

According to one or more embodiments of the present disclosure, the receiving module is further configured to receive a stop projection command;
the acquisition module is further configured to acquire the playback progress of the first video on the second device, where the stop projection command is used to control the first device to play the first video from the playback progress of the first video on the second device.

According to one or more embodiments of the present disclosure, the projection module is specifically configured to: send a second projection command to the second device, in response to determining that the projection of the first video is completed according to the playback progress of the first video on the second device. The second projection command includes video information of the second video, and the second projection command is used to control the second device to play the second video according to the video information of the second video.

According to one or more embodiments of the present disclosure, the projection module is specifically configured to: acquire the video information of the second video, and send a second projection command to the second device according to the video information of the second video, in response to determining that the projection of the first video is completed according to the playback progress of the first video on the second device.

According to one or more embodiments of the present disclosure, the projection module is specifically configured to: acquire the video information of the second video from a video information list; or
acquire the video information of the second video from a server.

According to one or more embodiments of the present disclosure, the acquisition module is specifically configured to: receive the playback progress of the first video on the second device from the second device.

According to one or more embodiments of the present disclosure, the video projection apparatus further includes: a display module. The receiving module is further configured to: receive a command for displaying a projection control icon. The display module is configured to display the projection control icon in response to the command for displaying the projection control icon. The projection control icon is used for projection control.

According to one or more embodiments of the present disclosure, the receiving module is specifically configured to: receive the command for displaying the projection control icon in the case that a display condition of the projection control icon is satisfied.

According to one or more embodiments of the present disclosure, the display condition of the projection control icon includes a condition that the projection application program of the first device transforms from a front-end running state to a background running state.

According to one or more embodiments of the present disclosure, the projection control icon is specifically used to: switch the video projected to the second device; and/or
control one or more of a playback progress, a playback volume, and a resolution of the projected video played on the second device.

According to one or more embodiments of the present disclosure, the receiving module is further configured to: receive a video switching command. The response module is further configured to: project a target video selected by a user to the second device in response to the video switching command.

According to one or more embodiments of the present disclosure, the response module is specifically configured to:
acquire a state of the projection application program in response to the video switching command; and
project the target video selected by the user to the second device, in the case that the projection application program is in a projection state.

According to one or more embodiments of the present disclosure, the response module is specifically configured to: send a third projection command to the second device. The third projection command includes video information of the target video selected by the user. The third projection command is used to: control the second device to play the target video according to the video information of the target video.

According to one or more embodiments of the present disclosure, the video information includes at least one of video data and a video address.

According to one or more embodiments of the present disclosure, in the case that the video information includes the video address, the second device is configured to acquire, according to the video address, video data corresponding to the video address.

According to one or more embodiments of the present disclosure, the video information further includes a projection parameter. The projection parameter includes at least one of a playback progress, a resolution and a playback volume.

According to one or more embodiments of the present disclosure, the projection parameter of the target video is consistent with a projection parameter of a historical projected video.

According to one or more embodiments of the present disclosure, the video projection apparatus further includes: a control module. The control module is configured to control a first player of the projection application program to enter a pause state, after the first video is projected to the second device or after the second video is projected to the second device.

According to one or more embodiments of the present disclosure, the receiving module is further configured to: receive a stop projection command. The response module is further configured to: control the first player to enter a playback state in response to the stop projection command.

According to one or more embodiments of the present disclosure, the control module is further configured to reactivate the first player when the projection of the first video is completed and the first player of the projection application program of the first device is turned off.

According to one or more embodiments of the present disclosure, the first projection command is further used to control a second player in the second device to be turned on, to play the first video.

According to one or more embodiments of the present disclosure, the second projection command is further used to control the second player in the second device to be turned on, to play the second video.

According to one or more embodiments of the present disclosure, the third projection command is further used to control the second player in the second device to be turned on, to play the target video.

According to one or more embodiments of the present disclosure, an electronic device is provided in the present disclosure. The electronic device includes:
one or more processors; and
a memory for storing one or more programs;
the one or more programs, when executed by the one or more processors, cause the one or more processors to implement the video projection method as provided in any one embodiments of the present disclosure.

According to one or more embodiments of the present disclosure, a computer-readable storage medium is provided according to the present disclosure, where o a computer program is stored on the computer-readable storage medium. The program, when executed by a processor, causes the processor to implement the video projection method as provided in any one embodiments of the present disclosure.

The above description is merely a preferred embodiment of the present disclosure and an illustration of the technical principles employed. Those skilled in the art should understand that the disclosed scope involved in the present disclosure is not limited to the technical solutions formed by the specific combination of the above technical features, and should also cover, without departing from the above disclosed concept, other technical solutions formed by any combination of the above technical features or its equivalent features, such as a technical solution formed by replacing the above features with technical features disclosed in the present disclosure (but not limited to) with similar functions.

Additionally, although operations are depicted in a particular order, this should not be construed as requiring that the operations are performed in the particular order shown or in a sequential order. Under certain circumstances, multitasking and parallel processing may be advantageous. Likewise, although the above discussion contains several specific implementation details, these should not be construed as limitations on the scope of the present disclosure. Certain features that are described in the context of separate embodiments may also be combined to implement in a single embodiment. Conversely, various features that are described in the context of a single embodiment may also be implemented in multiple embodiments separately or in any suitable sub-combination.

Although the subject matter has been described in language specific to structural features and/or logical acts of method, it is to be understood that the subject matter defined in the appended claims is not necessarily limited to the specific features or acts described above. Rather, the specific features and acts described above are merely example forms of implementing the claims.

1. A video projection method, applied to a first device, wherein the video projection method comprises:
receiving, by the first device, a start projection command;
projecting, by the first device, a first video to a second device in response to the start projection command;
acquiring, by the first device, a playback progress of the first video on the second device; and
determining, by the first device, that a projection of the first video is completed according to the playback progress of the first video on the second device; and projecting a second video to the second device, in response to a determination of the projection of the first video being completed.

2. The method according to claim 1, wherein the determining, by the first device, that a projection of the first video is completed according to the playback progress of the first video on the second device comprises:
determining that the projection of the first video is completed, in a case that the playback progress of the first video on the second device reaches a preset progress.

3. The method according to claim 2, wherein a projected video played on the second device comprises a head part, a plot part and an end part which are played in sequence;
wherein the preset progress is a playback progress when a playback of the plot part of the projected video is completed, or
the preset progress is a playback progress when a playback of the end part of the projected video is completed.

4. The method according to claim 1, wherein the projecting the first video to the second device comprises:
sending, by the first device, a first projection command to the second device, wherein the first projection command comprises video information of the first video, and the first projection command is used to control the second device to play the first video according to the video information of the first video.

5. The method according to claim 4, wherein the video information of the first video comprises a playback progress of the first video on the first device;
wherein the first projection command is used to control the second device to play the first video from the playback progress of the first video on the first device.

6. The method according to claim 5, further comprising:
receiving, by the first device, a stop projection command; and
acquiring, by the first device, the playback progress of the first video on the second device, wherein the stop projection command is used to control the first device to play the first video from the playback progress of the first video on the second device.

7. The method according to claim 1, wherein the determining, by the first device, that a projection of the first video is completed according to the playback progress of the first video on the second device; and projecting a second video to the second device, in response to a determination of the projection of the first video being completed comprises:
sending, by the first device, a second projection command to the second device, in response to determining that the projection of the first video is completed according to the playback progress of the first video on the second device, wherein the second projection command comprises video information of the second video, and the second projection command is used to control the second device to play the second video according to the video information of the second video.

8. The method according to claim 7, wherein the sending, by the first device, the second projection command to the second device, in response to determining that the projection of the first video is completed according to the playback progress of the first video on the second device comprises:
acquiring, by the first device, the video information of the second video; and
sending, by the first device, the second projection command to the second device according to the video information of the second video, in response to determining that the projection of the first video is completed according to the playback progress of the first video on the second device, and
wherein the acquiring, by the first device, the video information of the second video comprises:
acquiring, by the first device, the video information of the second video from a video information list; or
acquiring, by the first device, the video information of the second video from a server.

9. (canceled)

10. (canceled)

11. The method according to claim 1, further comprising:
receiving, by the first device, a command for displaying a projection control icon; and
displaying, by the first device, the projection control icon in response to the command for displaying the projection control icon, wherein the projection control icon is used for projection control.

12. The method according to claim 11, wherein the receiving, by the first device, a command for displaying a projection control icon comprises:
receiving, by the first device, the command for displaying the projection control icon, in a case that a display condition of the projection control icon is satisfied,
wherein the display condition of the projection control icon comprises a condition that a projection application program of the first device transforms from a front-end running state to a background running state.

13. (canceled)

14. The method according to claim 11, wherein the projection control icon is used to switch a video projected to the second device; and/or
control one or more of a playback progress, a playback volume, and a resolution of the projected video played on the second device.

15. The method according to claim 1, further comprising:
receiving, by the first device, a video switching command; and
projecting, by the first device, a target video selected by a user to the second device in response to the video switching command.

16. The method according to claim 15, wherein the projecting, by the first device, a target video selected by the user to the second device in response to the video switching command comprises:
acquiring, by the first device, a state of the projection application program in response to the video switching command; and
projecting, by the first device, the target video selected by the user to the second device, in a case that the projection application program is in a projection state.

17. The method according to claim 16, wherein the projecting the target video selected by the user to the second device comprises:
sending, by the first device, a third projection command to the second device, wherein the third projection command comprises video information of the target video selected by the user, and the third projection command is used to control the second device to play the target video according to the video information of the target video.

18. The method according to claim 4, wherein the video information comprises at least one of video data and a video address, and
in a case that the video information comprises the video address, the second device is configured to acquire, according to the video address, video data corresponding to the video address.

19. (canceled)

20. The method according to claim 18, wherein the video information further comprises a projection parameter;
the projection parameter comprises at least one of a playback progress, a resolution and a playback volume; and
a projection parameter of the target video is consistent with a projection parameter of a historical projected video.

21. (canceled)

22. The method according to claim 1, wherein after projecting the first video to the second device or after projecting the second video to the second device, the method further comprises:
controlling, by the first device, a first player in the projection application program to enter a pause state.

23. The method according to claim 22, wherein after controlling, by the first device, the first player in the projection application program to enter the pause state, the method further comprises:
receiving, by the first device, a stop projection command; and
controlling, by the first device, the first player to enter a playback state in response to the stop projection command.

24. The method according to claim 1, further comprising:
reactivating, by the first device, a first player, in a case that the projection of the first video is completed and the first player in the projection application program of the first device is turned off.

25. The method according to claim 4 or 5, wherein the first projection command is further used to control a second player in the second device to be turned on, to play the first video.

26. The method according to claim 7, wherein the second projection command is further used to control a second player in the second device to be turned on, to play the second video.

27. The method according to claim 17, wherein the third projection command is further used to control a second player in the second device to be turned on, to play the target video.

28. (canceled)

29. An electronic device, comprising:
one or more processors; and
a memory for storing one or more programs;
wherein the one or more programs, when executed by the one or more processors, cause the one or more processors to:
receive a start projection command;
project a first video to a second device in response to the start projection command;
acquire a playback progress of the first video on the second device;
determine that a projection of the first video is completed according to the playback progress of the first video on the second device; and
project a second video to the second device, in response to a determination of the projection of the first video being completed.

30. A non-transitory computer-readable storage medium on which a computer program is stored, wherein the program, when executed by a processor, cause the processor to:
receive a start projection command;
project a first video to a second device in response to the start projection command;
acquire a playback progress of the first video on the second device;
determine that a projection of the first video is completed according to the playback progress of the first video on the second device; and
project a second video to the second device, in response to a determination of the projection of the first video being completed.
